(19) United States
(12) Patent Application Publication
(10) Pub. No.: US 2011/0056104 A1
(43) Pub. Date: Mar. 10, 2011

(54) ADVERTISING SYSTEM APPLICABLE TO DOORS OF GARAGES, INDUSTRIAL PREMISES AND OTHERS

(76) Inventor: Francisco José Muñoz Hernández, Santa Cruz De Teneriff (Tenerife) (ES)

(21) Appl. No.: 12/920,611

(22) PCT Filed: Apr. 2, 2009
(86) PCT No.: PCT/IB2009/005168

§ 371 Date: Nov. 18, 2010

(30) Foreign Application Priority Data
Mar. 3, 2008 (ES) P200800617

(51) Int. Cl. G09F 15/00

(52) U.S. Cl. 40/606.07

(57) ABSTRACT

It is intended for being able to adapt advertising elements related to the doors in relation to their opening and closing, in such a way that normally, when the door is closed, the advertising is displayed in its entire extent, and when the door is open the advertising is hidden.

It is characterized in that it includes means for linking the advertising elements to the door, in such a way that when the door is closed, the advertising is displayed in its entirety in correspondence with the front surface of the door, hiding the same, while when the door is open the advertising elements leave the space for the door free, with the advertising being normally hidden.

### OBJECT OF THE INVENTION

As stated in the title of this descriptive specification, this invention relates to an advertising system applicable to the doors of garages, industrial premises and others, which presents as a novelty the possibility of being able to adapt advertising to various types of doors with the appropriate means, in such a way that when a door is closed the advertising is displayed, and when it is open the advertising becomes hidden.

Therefore, as the doors are closed for most of the time, the advertising will also be displayed during that same period of time.

### BACKGROUND OF THE INVENTION

There currently exist different types of garage door, notable among which are the rolling kind.

These doors do not display any kind of advertising, and at most the only thing they include is the actual make of the door or similar.

### DESCRIPTION OF THE INVENTION

The advertising system applicable to doors of garages, industrial premises and others, which constitutes the inventive object, is characterized in that it includes means for being linked to the structure and/or mechanism for opening and closing of a door, in such a way that when the door is in the closed position, which is most of the time, the advertising is displayed in its entirety, and when the door is open, which is for a short space of time, the advertising becomes hidden.

In a first embodiment, the advertising is fixed directly to the door itself, in correspondence with each part of that door. So, when the door is of the rolling kind, it includes rectangular segments that are hinged together, to each of which is fixed a laminar body with its advertising, the latter being able to form an overall motif or independent motifs.

In a second embodiment, the means for linking the advertising to the door consist of some vertical guides positioned at the limits of the portico for the door, in such a way that these vertical guides constitute the means for being able to displace an advertising panel or billboard simultaneously during the opening and closing of the door, in such a way that in the closed position the advertising panel will be kept located in front of the door associated with the said vertical guides, while in the open position of the door the panel will be able to be retracted or folded above the door, and even be kept extended above the door, with which the advertising will remain visible at all times.

In a third embodiment, provision has been made for some horizontal rails in front of the door: one at the height of the ground and the other at the height of or above the horizontal edge of the space for the door, in such a way that fitted to those rails will be a panel that is foldable in a zigzag formation, such that in the retracted position the panel can be provided on one or both sides of that door.

In a fourth embodiment, the inventive system comprises a laminar body which, in the retracted position will be rolled in a rotating drum inside a box in the manner of Venetian blinds.

In the second, third and fourth embodiments, the devices that actuate the advertising panel or laminar body will be able to be the same as that used for moving the door, with the possibility existing of having independent devices. In all cases, the activation will preferably be simultaneous.

The advertising system of the invention can also be applicable for emulating the doors of metro trains, making use of their opening and closing mechanism for the advertising supports.

Below, in order to facilitate a better understanding of this descriptive specification and forming an integral part thereof, some figures are accompanied in which the object of the invention has been represented by way of illustration and non-limiting.

### BRIEF DESCRIPTION OF THE DRAWINGS

FIG. 1.—Shows a view in perspective of a door for a garage, industrial premises and others, which incorporates the advertising system forming the inventive object. In this case the advertising is fixed to the door itself.

FIG. 2.—Shows a view similar to the above.

FIGS. 3 and 4.—Show views of another door with the incorporation of an advertising panel coupled to the vertical guides.

FIGS. 5 and 6.—Show some views of a zigzag advertising panel associated with the door.

FIG. 7.—Shows an advertising laminar body associated with the door and which rolls into the retracted position inside an upper box provided on top of the upper edge of the door.

### DESCRIPTION OF THE PREFERRED FORM OF EMBODIMENT

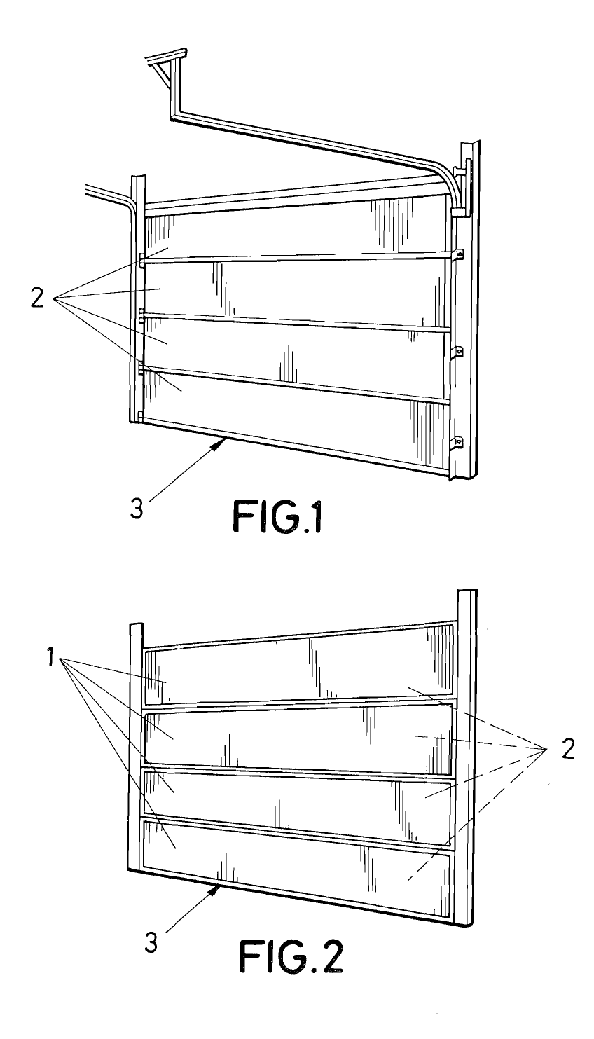

Considering the numbering adopted in the figures, the advertising system applicable to the doors of garages, industrial premises and others, in a first embodiment (FIGS. 1 and 2) comprises laminar bodies 1 which are stuck directly onto hinged rectangular segments 2 making up a door, which in the retracted position will be rolled inside an upper box not represented in the figures.

The advertising laminar bodies 1 can be protected from vandalism and adverse weather conditions with methacrylate plates or similar (not represented in the figures), of a thickness preferably no greater than 1.5 mm, all this being attached by means of screws similar to those used by the manufacturers of such doors, though others can be used as well.

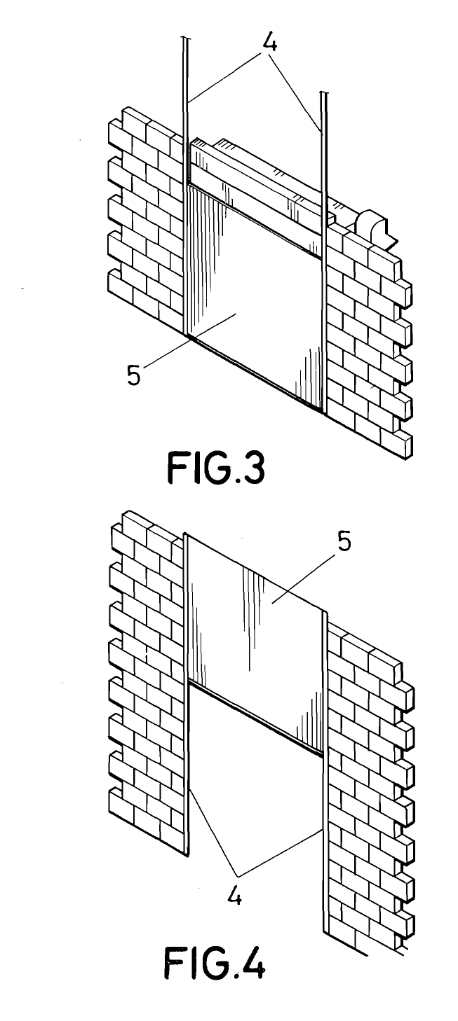

FIGS. 3 and 4 show other means for linking the advertising to the door, not represented.

They are defined on the basis of some vertical guides in the form of a “C” 4 fixed to the sides of the space for the door (not represented in the figures), with an advertising panel 5 being fixed to those guides 4 in such a way that, in the closed position of the door, the advertising panel 5 is arranged so that it is in front of the door, while when the door is open, the advertising panel 5 is located in an upper position leaving the space of the door entirely free.

One possibility of this second embodiment, when the door is open, is that the advertising panel 5 is located above the upper edge of the door in a vertical plane, with which the guides 4 are extended above the door.

Another possibility is for the advertising panel 5 to be able to roll in a drum inside a box, a possibility that is not represented in the figures since it is not considered necessary.

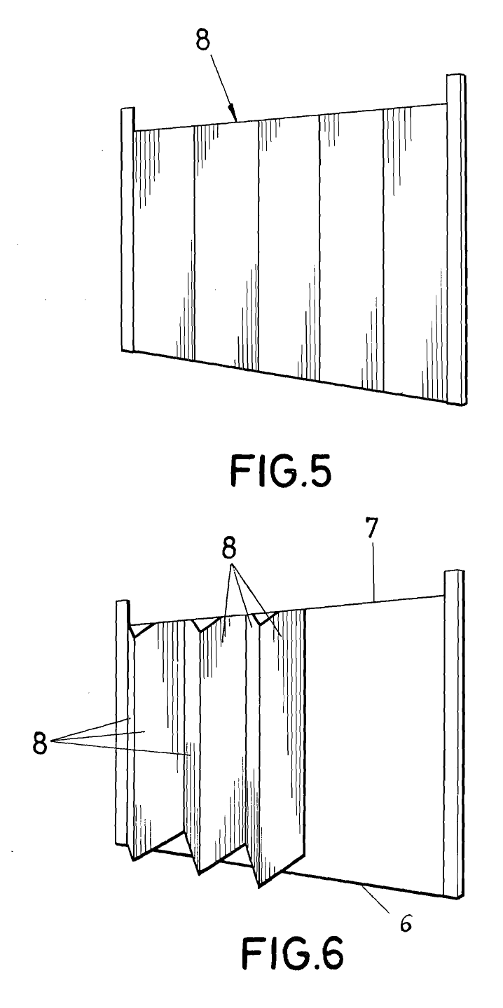

In another embodiment shown in FIGS. 5 and 6, a pair of horizontal rails has been provided, a lower one 6 at the height of the ground and an upper one 7 in an elevated zone above the upper edge of the door.

Coupled to those rails will be a panel 8 that is foldable in the form of a zigzag in the manner of an accordion, in such a way that in the extended position it will be arranged in front of the door while in the retracted position it will be arranged on one or both sides of the door.

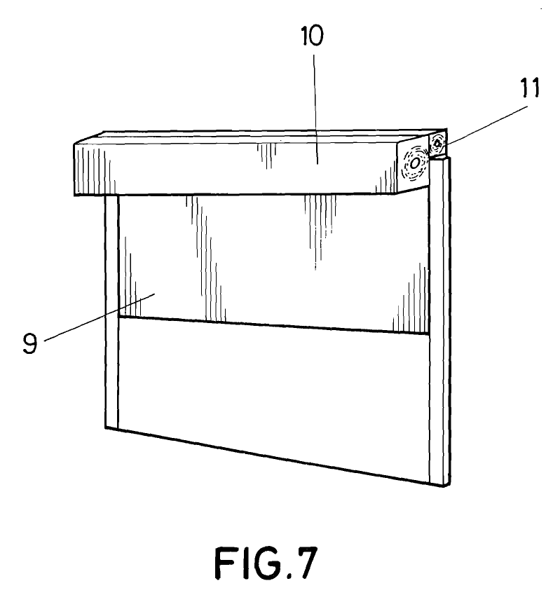

Finally, FIG. 7 shows an embodiment in which the advertising is printed on a flexible laminar body 9 which, in the extended position, is arranged in front of the door, while in the folded position it is rolled in a rotating drum housed inside a box 10 in the manner of a Venetian blind, which can be provided at the height of another box 11 where the rolling door can be housed, not represented in the figures.

1. ADVERTISING SYSTEM APPLICABLE TO DOORS OF GARAGES, INDUSTRIAL PREMISES AND OTHERS, which, being intended for being able to adapt advertising elements related to the respective door, is characterized in that it includes means for linking the advertising elements to a door, in such a way that when the door is closed, the advertising is displayed in its entirety in correspondence with the front face of the door, hiding the same, while when the door is open the advertising elements leave the space for the door free, the mechanism for opening and closing of the door being associated with the advertising elements in order to move them simultaneously towards the folded and extended position, and vice versa.

2. ADVERTISING SYSTEM APPLICABLE TO DOORS OF GARAGES, INDUSTRIAL PREMISES AND OTHERS, according to claim 1, characterized is in that the advertising is to be found on a panel (5) coupled in some vertical guides (4) via which it can be displaced upwards or downwards, these guides being established in the sides of the space for the door, in such a way that in the open position of the door said panel leaves the space for that door free while in the closed position the panel (5) is arranged in front of the door, hiding the same.

3. ADVERTISING SYSTEM APPLICABLE TO DOORS OF GARAGES, INDUSTRIAL PREMISES AND OTHERS, according to claim 2, characterized in that the advertising panel (5) is located in an upper position in an extended form above the upper edge of the door, the lateral guides (4) being prolonged above the said upper edge for that purpose.

4. ADVERTISING SYSTEM APPLICABLE TO DOORS OF GARAGES, INDUSTRIAL PREMISES AND OTHERS, according to claim 2, characterized in that the advertising panel is coupled to a drum located above the upper edge of the door.

5. ADVERTISING SYSTEM APPLICABLE TO DOORS OF GARAGES, INDUSTRIAL PREMISES AND OTHERS, according to claim 1, characterized in that the means for linking the advertising elements consist of some horizontal rails: a lower one (6) at the height of the ground and an upper one (7) in an elevated zone, with a panel that is foldable in the form of a zigzag in the manner of an accordion (8) being coupled in those rails (6 and 7), in such a way that in the extended position it will be arranged in front of the door while in the retracted position it will be arranged on one or both sides of the door.

6. ADVERTISING SYSTEM APPLICABLE TO DOORS OF GARAGES, INDUSTRIAL PREMISES AND OTHERS, according to claim 1, characterized in that the means for linking the advertising elements consist of an upper drum housed inside a box (10) above the door, in which drum is rolled a laminar body (9) which in the extended position is arranged in front of the door while in the folded position it is rolled in the upper drum housed inside the said box (10).
